(19) United States
(12) Patent Application Publication
(10) Pub. No.: US 2015/0012608 A1
(43) Pub. Date: Jan. 8, 2015

(54) WEB CONTENT PREFETCH CONTROL DEVICE, WEB CONTENT PREFETCH CONTROL PROGRAM, AND WEB CONTENT PREFETCH CONTROL METHOD

(71) Applicant: Panasonic Intellectual Property Corporation of America, Torrance, CA (US)

(72) Inventor: Hiroo Ishikawa, Osaka (JP)

(73) Assignee: Panasonic Intellectual Property Corporation of America, Torrance, CA (US)

(21) Appl. No.: 14/373,464

(22) PCT Filed: Jun. 28, 2013
(86) PCT No.: PCT/JP2013/004044

§ 371 Date: Jul. 21, 2014

(30) Foreign Application Priority Data
Aug. 31, 2012 (JP) 2012-190932

(51) Int. Cl. H04L 29/08; G06F 17/30; H04L 29/06

(52) U.S. Cl. CPC H04L 67/28; H04L 67/42; G06F 17/3089
USPC 709/213

(57) ABSTRACT

A web content prefetch control device includes a client connecting unit which receives a Web content acquisition request from a client, and a prefetch request from a prefetch processing unit which performs prefetch of Web content; a cache managing unit which stores Web content acquired as responses to the Web content acquisition request and to the prefetch request, and transmits the responses; a response replication unit which receives the responses from the cache managing unit, and replicates the response to the Web content acquisition request, out of the responses; and a prefetch connecting unit which transmits, to the prefetch processing unit, the replicated response to the Web content acquisition request. Communication between the client connecting unit and the client, communication between the client connecting unit and the prefetch processing unit, and communication between the prefetch connecting unit and the prefetch processing unit are each performed with a same communication protocol.

### TECHNICAL FIELD

The present invention relates to a Web content prefetch control device configured to allow the user to perform high-speed Webpage browsing by prefetching and caching data.

### BACKGROUND ART

In the WWW system, there is known a prefetch technique, as a technique for eliminating a delay in acquiring Web content. According to the prefetch technique, for instance, Web access is stabilized and sped up by extracting content which is supposed to be accessed by the user in the future from e.g. a user browsing history, and by reading the content from a remote Web server via a network, and by caching (temporarily storing) the content in a proxy server or in a Web browser.

For instance, patent literature 1 discloses a technology, in which a page acquired from a Web server by a Web browser is analyzed, and if dynamic content is linked to the page, a dummy request is transmitted to the Web server, and the Web server which has received the dummy request generates a page, and the generated page is stored in a cache without being transmitted to the Web browser.

Further, patent literature 2 discloses a technology, in which an information storage server configured to store in advance Web information prefetched by a prefetch representative server is provided between the prefetch representative server and a PC in order to shorten a network delay time between the prefetch representative server and the PC.

In the aspect of securing versatility and reducing the development load in implementing the prefetch technique, it is necessary to reduce the amount of change with respect to a proxy server or a Web browser as much as possible. Patent literature 1, however, merely discloses prefetching a dynamic link. Further, in patent literature 2, it is necessary to mount a communication interface of an information storage server as a dedicated interface. Therefore, it is impossible to configure an information storage server unless an existing proxy server is drastically changed.

### CITATION LIST

### Patent Literature

Patent literature 1: Japanese Unexamined Patent Publication No. 2011-108102

Patent literature 2: Japanese Unexamined Patent Publication No. 2012-3652

### SUMMARY OF INVENTION

In view of the above, an object of the invention is to provide a Web content prefetch control device provided with a prefetch function, while reducing the amount of change with respect to a proxy server.

A Web content prefetch control device according to an aspect of the invention is a Web content prefetch control device connected to a Web server for storing Web content via a network, and configured to control prefetch of Web content linked to Web content in the Web server requested by a client. The Web content prefetch control device is provided with a client connecting unit which receives a Web content acquisition request from the client, and a prefetch request transmitted from a prefetch processing unit which performs the prefetch of Web content; a cache managing unit which stores Web content acquired from the Web server as responses to the Web content acquisition request and to the prefetch request, and transmits the responses; a response replication unit which receives the responses transmitted from the cache managing unit, and replicates the response to the Web content acquisition request, out of the responses; and a prefetch connecting unit which transmits, to the prefetch processing unit, the replicated response to the Web content acquisition request. In the above configuration, communication between the client connecting unit and the client, communication between the client connecting unit and the prefetch processing unit, and communication between the prefetch connecting unit and the prefetch processing unit are each performed with a same communication protocol.

### BRIEF DESCRIPTION OF DRAWINGS

FIG. 1 is a diagram illustrating an example of the overall configuration of a system including a Web content prefetch control device according to an embodiment;

FIG. 2 is a diagram illustrating an example of a data configuration of a connection object in the embodiment;

FIG. 3 is a diagram illustrating an example of a data configuration of a request object in the embodiment;

FIG. 4 is a diagram illustrating an example of a data configuration of a cache object in the embodiment;

FIG. 5 is a sequence diagram illustrating an example of the overall operation to be performed by the system in the embodiment;

FIG. 6A is a diagram illustrating an example of a prefetch request message for use in establishing communication connection between a prefetch connecting unit and a prefetch processing unit in the embodiment;

FIG. 6B is a diagram illustrating an example of a prefetch request message for use in prefetching Web content;

FIG. 7 is a flowchart illustrating an example of a request process in the embodiment;

FIG. 8 is a flowchart illustrating an example of a server request process in the embodiment;

FIG. 9 is a flowchart illustrating an example of a response process in the embodiment;

FIG. 10 is a flowchart illustrating an example of a replication preparing process in the embodiment;

FIG. 11 is a flowchart illustrating an example of a replication process in the embodiment;

FIG. 12 is a flowchart illustrating an example of a cut-off process in the embodiment;

FIG. 13 is a flowchart illustrating an example of a link analysis process in the embodiment;

FIG. 14 is a flowchart illustrating an example of a prefetch request process in the embodiment;

FIG. 15 is a diagram illustrating an example of a configuration of a system including a Web content prefetch control device when a client is included in the Web content prefetch control device;

FIG. 16 is a diagram illustrating an example of a configuration of a system including a Web content prefetch control device when an information storage unit, a prefetch processing unit, and a client are constituted of computers different from each other;

FIG. 17 is a diagram illustrating an example of a configuration of a system including a Web content prefetch control device when an information storage unit, a client, and a prefetch processing unit are constituted of computers different from each other;

FIG. 18 is a diagram illustrating an example of a hardware configuration of a computer when a Web content prefetch control device is implemented by the computer; and

FIG. 19 is a configuration diagram of a conventional Web content prefetch control device.

### DESCRIPTION OF EMBODIMENTS

Preface for Embodiment of the Invention

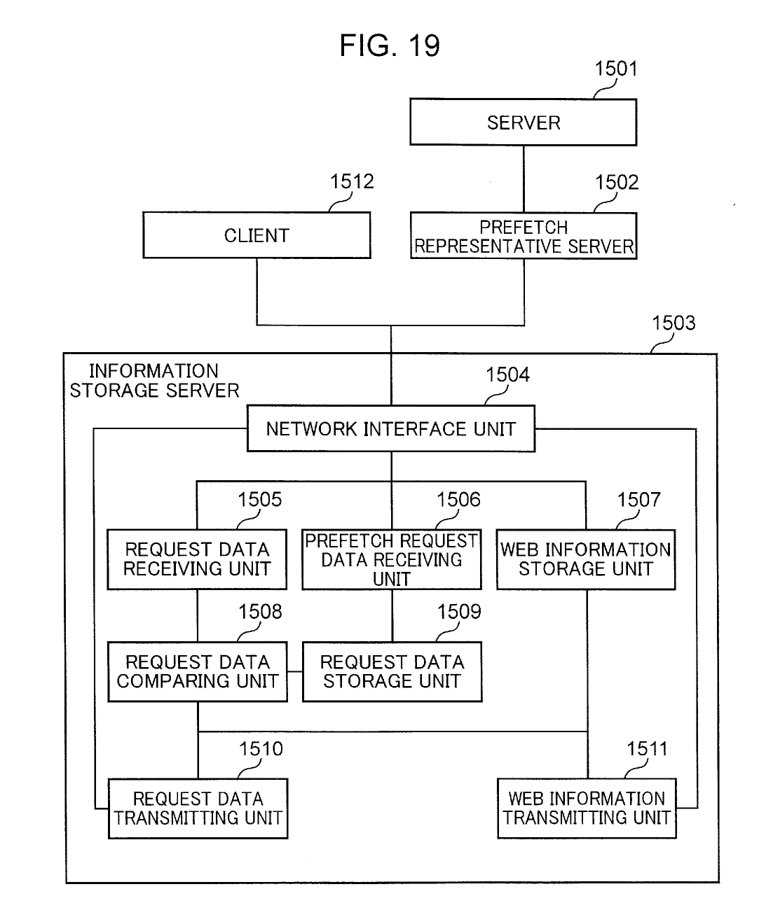

FIG. 19 is a block diagram of a conventional Web content prefetch control device as disclosed in patent literature 2. The Web content prefetch control device is provided with a prefetch representative server 1502 and an information storage server 1503. A server 1501 is a Web server, and is connected to the prefetch representative server 1502 via the Internet. The prefetch representative server 1502 is connected to the information storage server 1503 via an ultra delay network of a low speed, as compared with the Internet or an LAN. The information storage server 1503 is connected to a client 1512 via an LAN.

The information storage server 1503 is a proxy server configured to receive request data for acquiring Web information of the client 1512, to acquire the Web information from the server 1501, and to transmit the acquired Web information to the client 1512. The information storage server 1503 caches in advance Web information prefetched from the server 1501 by the prefetch representative server 1502. Accordingly, the information storage server 1503 is capable of speedily transmitting Web information to the client 1512, if the Web information is cached at the time of issuance of request data from the client 1512.

The above configuration is described in detail in the following. Referring to FIG. 19, when the client 1512 issues request data for acquiring Web information, a request data receiving unit 1505 in the information storage server 1503 receives the request data via a network interface unit 1504. Subsequently, a request data comparing unit 1508 determines whether request data identical to the received request data is stored in a request data storage unit 1509.

When the request data comparing unit 1508 determines that the same request data is stored in the request data storage unit 1509, the request data comparing unit 1508 inquires whether Web information requested by the request data is stored in the Web information storage unit 1507, and instructs a Web information transmitting unit 1511 to transmit the Web information to the client 1512, if the Web information is stored in the Web information storage unit 1507. In response to receiving the instruction, the Web information transmitting unit 1511 extracts the Web information from the Web information storage unit 1507, and transmits the extracted Web information to the client 1512, with use of the network interface unit 1504.

On the other hand, in the case where the request data comparing unit 1508 determines that the same request data is not stored in the request data storage unit 1509, the request data is transmitted to the prefetch representative server 1502 via the request data transmitting unit 1510 and via the network interface unit 1504. In response to receiving the request data, the prefetch representative server 1502 prefetches, from the server 1501, Web information relating to the Web information to be acquired by the request data, and transmits the prefetched Web information to the information storage server 1503 all at once.

In the conventional Web content prefetch control device having the above configuration, the information storage server 1503 as a proxy server is completely independent from the prefetch representative server 1502. It is sufficient for the information storage server 1503 to function as a server with respect to the client 1512. However, the information storage server 1503 is required to function as a client with respect to the prefetch representative server 1502. Accordingly, the information storage server 1503 is required to use independent communication means in order to communicate with the prefetch representative server 1502. It is necessary to mount the network interface unit 1504 as a dedicated interface in order to implement the above operation. In the conventional Web content prefetch control device, it is impossible to implement the information storage server 1503, unless an existing proxy server is drastically changed.

In view of the above, the inventor found an approach as described in the following embodiment. In the following, an embodiment of the invention is described referring to the drawings.

### EMBODIMENT

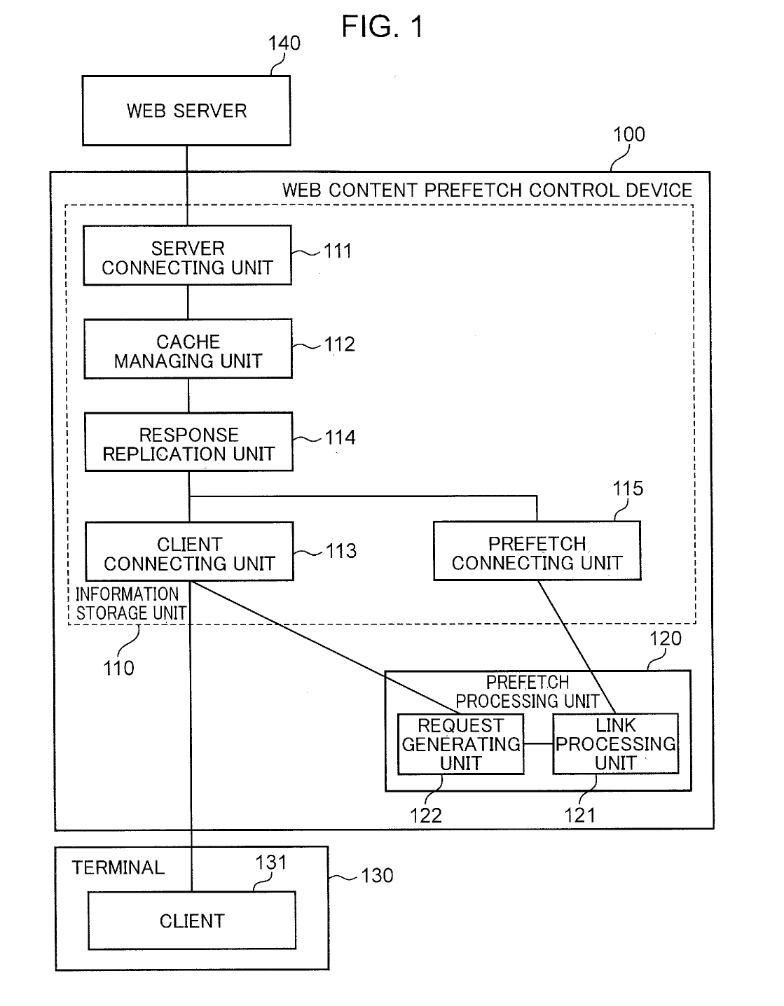

FIG. 1 is a block diagram illustrating an example of the overall configuration of a system including a Web content prefetch control device 100 according to an embodiment.

The Web content prefetch control device 100 is connected to each of a terminal 130 and a Web server 140 via a network. An example of the network between the Web content prefetch control device 100 and the Web server 140 is the Internet. Further, examples of the network between the Web content prefetch control device 100 and the terminal 130 are an LAN (Local Area Network) or the Internet. In any case, as far as an Internet protocol such as TCP/IP is employed as a network, any network may be used.

The terminal 130 is constituted of e.g. a computer, and is provided with a client 131. The client 131 is implemented by causing a processor in the terminal 130 to execute a predetermined program. The client 131 has a function of generating and transmitting an HTTP (Hypertext Transfer Protocol) request in accordance with the user's request, and a function of interpreting and presenting an HTTP response (an example of a response) to the user. An example of the client 131 is a Web browser. The client 131 may interpret an HTTP response and generate image data or sound data, and may present an HTTP response to the user by displaying the HTTP response on a display unit of the terminal 130 or by outputting sounds indicating the HTTP response from a speaker.

The Web server 140 is constituted of e.g. a computer. The Web server 140 is configured to store original Web content, to receive an HTTP request to be transmitted from the client 131, to interpret the received HTTP request for specifying the Web content, of which acquisition is requested by the HTTP request, and to transmit the specified Web content to the client 131 as an HTTP response.

The Web content prefetch control device 100 is constituted of e.g. a computer. In response to receiving Web access to the Web server 140 from the client 131, the Web content prefetch control device 100 accesses the Web server 140 as a representative of the client 131, acquires an HTTP response from the Web server 140, and transmits the acquired HTTP response to the client 131. Further, the Web content prefetch control device 100 is configured to prefetch Web content linked to Web content acquired as an HTTP response from the Web server 140.

The Web content prefetch control device 100 is provided with an information storage unit 110 and a prefetch processing unit 120.

In response to receiving a Web content acquisition request from the client 131 or receiving a prefetch request from the prefetch processing unit 120, the information storage unit 110 accesses the Web server 140, and acquires an HTTP response from the Web server 140. The information storage unit 110 is configured to store Web content acquired as an HTTP response from the Web server 140, and to transmit the Web content to the client 131 and to the prefetch processing unit 120, as necessary. In performing the above operation, the information storage unit 110 communicates with each of the client 131, the Web server 140, and the prefetch processing unit 120 by using an HTTP. In the embodiment, the information storage unit 110 functions as a proxy server.

The information storage unit 110 is provided with a server connecting unit 111, a cache managing unit 112, a client connecting unit 113, a response replication unit 114, and a prefetch connecting unit 115.

The server connecting unit 111 has a function of managing communication connection with the Web server 140, and of transmitting and receiving an HTTP message to and from the Web server 140. Specifically, the server connecting unit 111 is configured to receive an HTTP request from the cache managing unit 112 for transmitting the received HTTP request to the Web server 140, and to receive an HTTP response from the Web sever 140 for transmitting the received HTTP response to the cache managing unit 112. Examples of the HTTP message include an HTTP request, and an HTTP response as a response to the HTTP request. A typical example of the HTTP message is a message in accordance with RFC 2616.

The Web content prefetch control device 100 is provided with a storage device (not illustrated) such as a main memory or a hard disk. A dedicated cache area is provided in the storage device.

The cache managing unit 112 is configured to store HTTP responses acquired from the Web server 140 in the cache area. In response to receiving an HTTP request from the client connecting unit 113, the cache managing unit 112 retrieves an HTTP response to the HTTP request from the HTTP responses stored in the cache area. In the case where there is an HTTP response to the received HTTP request as a retrieval result, the cache managing unit 112 transmits the HTTP response to the response replication unit 114. On the other hand, in the case where there is no HTTP response to the received HTTP request, the cache managing unit 112 transmits the received HTTP request to the server connecting unit 111.

The client connecting unit 113 has a function of transmitting and receiving an HTTP message to and from the client 131 and to and from the prefetch processing unit 120. Specifically, the client connecting unit 113 is configured to receive an ordinary HTTP request (an example of a Web content acquisition request) from the client 131 and a prefetch-related HTTP request from the prefetch processing unit 120, and to transmit the HTTP requests to the cache managing unit 112. In performing the above operation, the client connecting unit 113 may directly transmit the HTTP requests to the cache managing unit 112, or may indirectly transmit the HTTP requests via the response replication unit 114. In the case where the HTTP requests are indirectly transmitted via the response replication unit 114, the response replication unit 114 transmits the received HTTP requests to the cache managing unit 112, without processing the received HTTP requests.

Further, the client connecting unit 113 is configured to receive an ordinary HTTP request from the response replication unit 114, and to transmit the received ordinary HTTP request to the client 131 and to the prefetch processing unit 120.

Further, the client connecting unit 113 is configured to manage communication connection with the client 131 in transmitting and receiving an HTTP message to and from the client 131, and to manage communication connection with the prefetch processing unit 120 in transmitting and receiving an HTTP message to and from the prefetch processing unit 120. Specifically, the client connecting unit 113 is configured to manage communication connection with the client 131 and with the prefetch processing unit 120, with use of a connection object indicating communication connection to be established in transmitting and receiving an HTTP message. A practical example of the connection object will be described later.

The response replication unit 114 is configured to receive an HTTP response from the cache managing unit 112, and to transmit the received HTTP response to the client connecting unit 113. In performing the above operation, in the case where the received HTTP response is an ordinary HTTP response to an ordinary HTTP request, the response replication unit 114 replicates the ordinary HTTP response, and transmits the replicated HTTP response to the prefetch connecting unit 115. In other words, in response to receiving an ordinary HTTP response from the cache managing unit 112, the response replication unit 114 transmits the ordinary HTTP response to the client connecting unit 113, and transmits a replicated ordinary HTTP response to the prefetch connecting unit 115. By performing the above operation, the ordinary HTTP response is transmitted to the client 131 via the client connecting unit 113, and the client 131 displays the received ordinary HTTP response on the display unit. Further, the ordinary HTTP response is transmitted to the prefetch processing unit 120 via the prefetch connecting unit 115, and the prefetch processing unit 120 analyzes the link destination of the HTTP response.

On the other hand, in the case where the received HTTP response is an HTTP response (hereinafter, called as a “prefetch-related HTTP response”) to a prefetch-related HTTP request, the response replication unit 114 does not replicate the prefetch-related HTTP response, and does not transmit the prefetch-related HTTP response to the prefetch connecting unit 115. This makes it possible to prevent prefetch of a prefetched HTTP response, thereby preventing a chain of prefetches.

The response replication unit 114 may or may not receive an HTTP request from the client connecting unit 113. In the case where the response replication unit 114 receives an HTTP request from the client connecting unit 113, the response replication unit 114 may transmit the received HTTP request to the cache managing unit 112 as it is.

The prefetch connecting unit 115 is configured to transmit an ordinary HTTP response received from the response replication unit 114 to the prefetch processing unit 120. Further, the prefetch connecting unit 115 is configured to manage communication connection with the prefetch processing unit 120 in transmitting an HTTP response to the prefetch processing unit 120. In this example, the prefetch connecting unit 115 may manage communication connection with use of a connection object indicating communication connection to be established between the prefetch connecting unit 115 and the prefetch processing unit 120. A practical example of the connection object will be described later.

Further, in the embodiment, the client connecting unit 113 and the prefetch connecting unit 115 are functional blocks different from each other. The prefetch connecting unit 115 is substantially the same as the client connecting unit 113 except that the prefetch connecting unit 115 transmits a prefetch-related HTTP response to the prefetch processing unit 120. Accordingly, the client connecting unit 113 may have the function of the prefetch connecting unit 115, and the prefetch connecting unit 115 may be omitted from the Web content prefetch control device 100.

The Web content prefetch control device 100 as described above is configured such that communication between the client connecting unit 113 and the client 131, communication between the client connecting unit 113 and the prefetch processing unit 120, and communication between the prefetch connecting unit 115 and the prefetch processing unit 120 are performed with use of a same communication protocol (e.g. the aforementioned HTTP).

Therefore, it is possible to implement the information storage unit 110 by adding the response replication unit 114 and the prefetch connecting unit 115 to a conventional proxy server provided with the server connecting unit 111, the cache managing unit 112, and the client connecting unit 113. Further, the proxy server is capable of handling the prefetch processing unit 120 as an independent process, and is capable of handling the prefetch processing unit 120 as a client, as well as the client 131. Accordingly, it is possible to configure the Web content prefetch control device 100, while reducing the amount of change with respect to a conventional proxy server.

It is possible to implement the information storage unit 110 and the prefetch processing unit 120 as processes running on a computer to be independent from each other. These processes are communicable with each other, with use of a predetermined communication protocol. An example of the predetermined communication protocol is HTTP.

The prefetch processing unit 120 is configured to analyze a prefetch-related HTTP response received from the prefetch connecting unit 115, and to transmit a prefetch-related HTTP request to the client connecting unit 113. The prefetch processing unit 120 is provided with a link processing unit 121 and a request generating unit 122.

The link processing unit 121 is configured to extract a link included in an HTTP response received from the prefetch connecting unit 115, and to transfer link information indicating the extracted link to the request generating unit 122. In the case where a plurality of links are included in an HTTP response, the link processing unit 121 extracts the plurality of links.

The request generating unit 122 is configured to generate an HTTP request to the link indicated by the link information, based on the link information received from the link processing unit 121, and to transmit the generated HTTP request to the client connecting unit 113. In the case where the request generating unit 122 receives a plurality of link information from the link processing unit 121, the request generating unit 122 generates one HTTP request to one link.

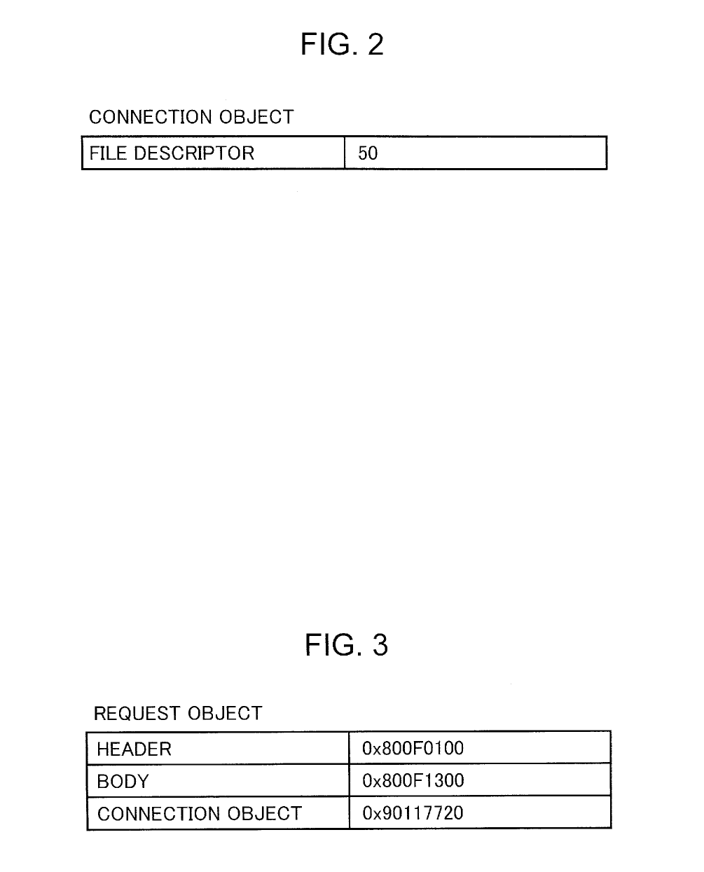

FIG. 2 is a diagram illustrating an example of a data configuration of a connection object to be managed by the client connecting unit 113 and by the prefetch connecting unit 115. The connection object is provided with a field “FILE DESCRIPTOR”. A file descriptor as an identifier of communication connection is registered in the field “FILE DESCRIPTOR”. In the example of FIG. 2, “50” is registered in the field “FILE DESCRIPTOR”.

FIG. 3 is a diagram illustrating an example of a data configuration of a request object for use in processing an HTTP request by the information storage unit 110. The request object is provided with fields “HEADER”, “BODY”, and “CONNECTION OBJECT”. A memory address for storing a header portion constituting an HTTP request is registered in the field “HEADER”. A memory address for storing a body portion constituting an HTTP request is registered in the field “BODY”. A pointer to a connection object indicating communication connection is registered in the field “CONNECTION OBJECT” in order to transmit an HTTP response to the communication connection which has received an HTTP request. In the example of FIG. 3, “0x800F0100” is registered in the field “HEADER” as a memory address for storing the header portion, “0x800F1300” is registered in the field “BODY” as a memory address for storing the body portion, and “0x90117720” is registered in the field “CONNECTION OBJECT” as a pointer to the connection object.

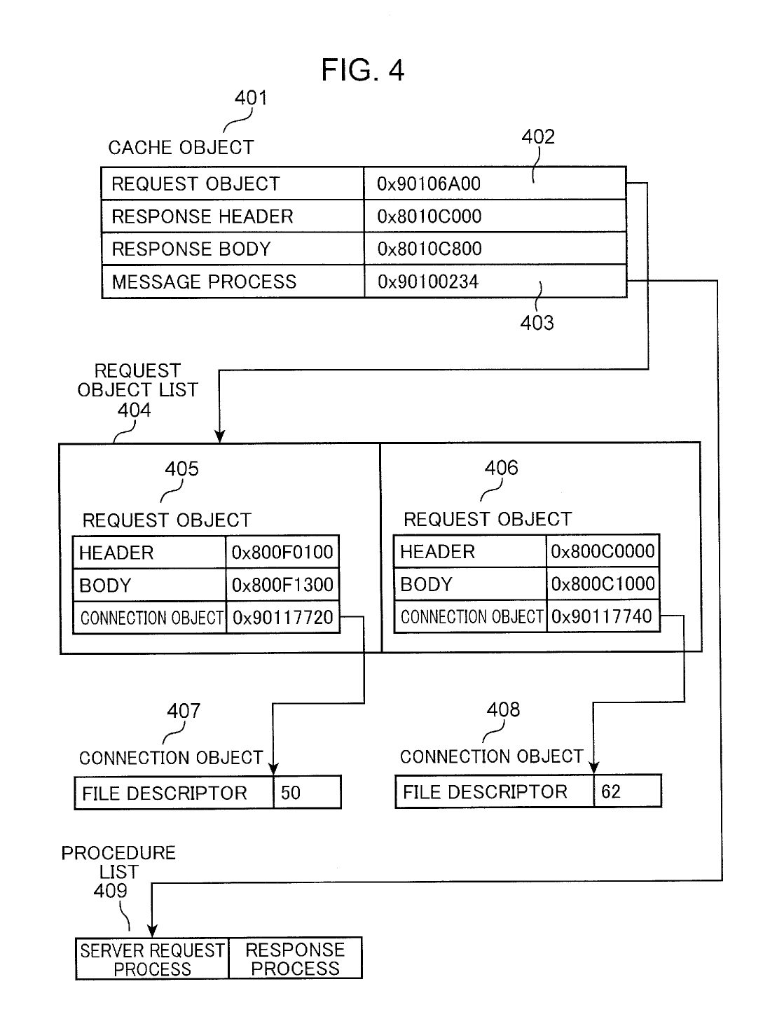

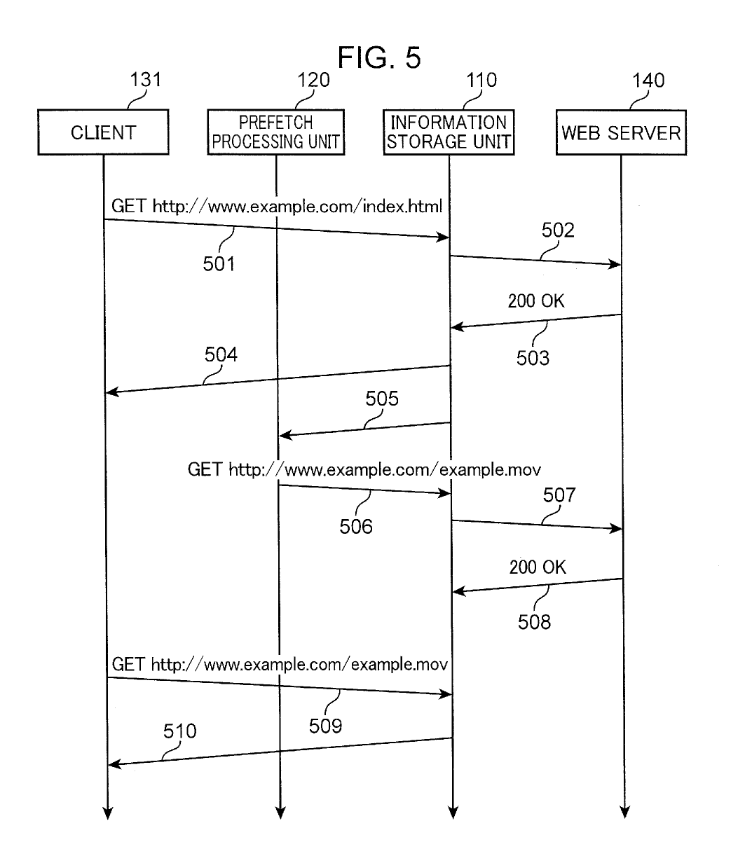

FIG. 4 is a diagram illustrating an example of a data configuration of a cache object 401 to be managed by the cache managing unit 112. The cache object 401 is provided with fields “REQUEST OBJECT”, “RESPONSE HEADER”, “RESPONSE BODY”, and “MESSAGE PROCESS”. A pointer to a request object list 404 is registered in the field “REQUEST OBJECT” as indicated by the reference sign 402. A pointer to a header portion constituting an HTTP response transmitted from the Web server 140 is registered in the field “RESPONSE HEADER”. A pointer to a body portion constituting an HTTP response is registered in the field “RESPONSE BODY”. A pointer to a procedure list 409 is registered in the field “MESSAGE PROCESS” as indicated by the reference sign 403.

In the example of FIG. 4, “0x9016A00” is registered in the field “REQUEST OBJECT” as a pointer to the request object list 404, “0x80100000” is registered in the field “RESPONSE HEADER” as a memory address of the response header, “0x80100800” is registered in the field “RESPONSE BODY” as a memory address of the response body, and “0x90100234” is registered in the field “MESSAGE PROCESS” as a pointer to the procedure list 409.

The request object list 404 is associated with the cache object 401 by the pointer registered in the field “REQUEST OBJECT” as indicated by the reference sign 402 in the cache object 401. In the example of FIG. 4, the request object list 404 includes two request objects i.e. a request object 405 and a request object 406. These two request objects are associated with the cache object 401. Further, in the example of FIG. 4, a pointer to a connection object 407 and a pointer to a connection object 408 are respectively registered in the request object 405 and in the request object 406. According to this configuration, the request object 405 is associated with the connection object 407, and the request object 406 is associated with the connection object 408.

Further, in the example of FIG. 4, the procedure list 409 is associated with the cache object 401 by the pointer registered in the field “MESSAGE PROCESS” as indicated by the reference sign 403 in the cache object 401. A server request process and a response process are registered in the procedure list 409. The server request process is a process for acquiring, from the Web server 140, HTTP responses to HTTP requests indicated by the request objects 405 and 406. The response process is a process for transmitting HTTP responses to HTTP requests indicated by the response objects 405 and 406 to the client 131 and to the prefetch processing unit 120.

FIG. 5 is a sequence diagram illustrating an example of the overall operation to be performed by a system including the Web content prefetch control device 100 according to the embodiment.

The client 131, the prefetch processing unit 120, the information storage unit 110, and the Web server 140 are configured as illustrated in FIG. 1, and are communicated to each other by using an HTTP. In the example of FIG. 5, the Web server 140 is identified by the domain name “www.example.com”, and the client 131 is configured to access the content stored in the Web server 140, with the file name “index.html”.

Further, “index.html” includes a link to “www.example.com/example.mov”. Further, before start of the operation indicated by the example illustrated in FIG. 5, “index.html” and “example.mov” are not stored in the information storage unit 110.

First of all, the client 131 transmits an ordinary HTTP request for acquiring the Web content referred to by “www.example.com/index.html” to the information storage unit 110 (in Step 501).

The information storage unit 110 retrieves the target Web content from the cache to be managed by the information storage unit 110. In the example of FIG. 5, since there is no entry to “index.html”, the information storage unit 110 transfers an ordinary HTTP request to the Web server 140 referred to by “www.example.com” (in Step 502).

Since the Web server 140 stores the Web content referred to by “index.html”, the Web server 140 transmits “index.html” together with a status code (200 OK) indicating that the request was successful to the information storage unit 110 (in Step 503).

The information storage unit 110 stores the Web content (index.html) received from the Web server 140 in a cache area dedicatedly provided in a storage device (not illustrated) such as a main memory or a hard disk owned by the Web content prefetch control device 100, and transmits the Web content to the client 131 (in Step 504).

In performing the above operation, the information storage unit 110 replicates the Web content received in Step 503, and transmits the replicated Web content to the prefetch processing unit 120 as well as to the client 131 (in Step 505).

The prefetch processing unit 120 extracts the link (www.example.com/example.mov) of the received content, generates a prefetch-related HTTP request, and transmits the generated prefetch-related HTTP request to the information storage unit 110 (in Step 506).

In response to receiving the prefetch-related HTTP request from the prefetch processing unit 120, the information storage unit 110 retrieves the cache area to be managed by the information storage unit 110, as well as the ordinary HTTP request transmitted from the client 131. In the example of FIG. 5, since there is no entry to “example.mov”, the information storage unit 110 transfers the prefetch-related HTTP request to the Web server 140 (in Step 507).

Since the Web server 140 stores the content to be referred to by “example.mov”, the Web server 140 transmits the Web content referred to by “example.mov” together with a status code (200 OK) indicating that the request was successful to the information storage unit 110 (in Step 508).

The information storage unit 110 stores the content (example.mov) received from the Web server 140 in the cache memory to be managed by the information storage unit 110. In Step 506, the HTTP request received by the information storage unit 110 is a prefetch-related HTTP request. Accordingly, the information storage unit 110 does not transmit a reply indicating that the HTTP request was successful to the prefetch processing unit 120 at the point of time when Step 508 is finished. This, however, is merely an example. The information storage unit 110 may transmit the reply to the prefetch processing unit 120 at the point of time when Step 508 is finished.

Subsequently, the client 131 transmits an ordinary HTTP request for acquiring the content to be referred to by “www.example.com/example.mov” to the information storage unit 110 (in Step 509). The ordinary HTTP request is transmitted by the user's clicking the link to ^{“}www.example.com/example.mov” included in “index.html” received by the client 131 in Step 504. with use of e.g. an input device.

The information storage unit 110 retrieves the cache area to be managed by the information storage unit 110. In this case, since the prefetch processing unit 120 has transmitted a prefetch-related HTTP request in Step 506, the Web content (example.mov) is cached. Accordingly, the information storage unit 110 transmits the cached Web content to the client 131, without transferring the HTTP request to the Web server 140 (in Step 510).

In the example of FIG. 5, by performing the above operation, the Web content to be referred to by “www.example.com/example.mov” is prefetched in accordance with an HTTP request for acquiring “www.example.com/index.html” to be issued from the client 131, and is cached in the information storage unit 110. Accordingly, the Web content to be referred to by “www.example.com/example.mov” is cached in the information storage unit 110 before the client 131 issues an ordinary HTTP request for acquiring the Web content.

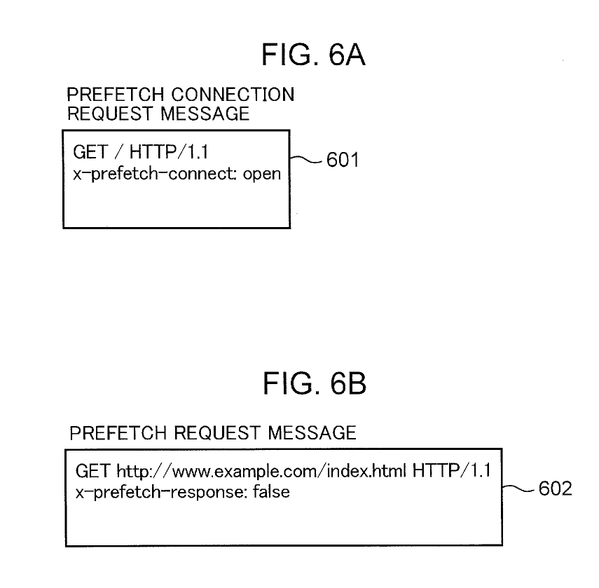

FIG. 6A and FIG. 6B are diagrams illustrating an example of an HTTP request to be generated by the prefetch processing unit 120 and to be transmitted to the information storage unit 110.

FIG. 6A is a diagram illustrating an example of a prefetch request message 601 (a first prefetch request) for use in establishing communication connection between the prefetch connecting unit 115 and the prefetch processing unit 120. The prefetch request message 601 is an HTTP request to be transmitted to the client connecting unit 113 from the prefetch processing unit 120 in order to establish communication connection with the prefetch connecting unit 115. It is necessary to discriminate the prefetch request message 601 from an ordinary HTTP request to be transmitted from the client 131 or from a prefetch request message 602 for use in prefetching the Web content illustrated in FIG. 6B. It is possible to define a character string indicating the prefetch request message 601 in the header portion in the format of an HTTP request to be defined by RFC 2616. In the embodiment, an example of the character string indicating the prefetch request message 601 is “x-prefetch-connect: open”. On the other hand, “x-prefetch-connect: open” is not described in the header portion of an ordinary HTTP request from the client 131 or in the header portion of the prefetch request message 602 to be described later. According to this configuration, the client connecting unit 113 is capable of discriminating the prefetch request message 601 by the presence or absence of “x-prefetch-connect: open”. The character string for use in discriminating the prefetch request message 601 is merely an example. Any character string may be used, as far as it is possible to discriminate the character string from other request messages.

FIG. 6B is a diagram illustrating an example of the prefetch request message 602 for use in prefetching Web content. The prefetch request message 602 is an HTTP request to be transmitted in instructing the information storage unit 110 to prefetch the Web content by the prefetch processing unit 120. The prefetch request message 602 is transmitted from the prefetch processing unit 120 to the client connecting unit 113 after the communication connection between the prefetch processing unit 120 and the prefetch connecting unit 115 is established by the prefetch request message 601.

It is necessary to discriminate the prefetch request message 602 from an ordinary HTTP request to be transmitted from the client 131. It is possible to define a character string indicating the prefetch request message 602 in the HTTP header in the format of an HTTP request to be defined by RFC 2616. In the embodiment, an example of the character string of the HTTP header indicating the prefetch request message 602 is “x-prefetch-response: false” (an example of type information). On the other hand, “x-prefetch-response: false” is not described in the header portion of an ordinary HTTP request to be transmitted from the client 131. According to the above configuration, the response replication unit 114 is capable of discriminating the prefetch request message 602 by the presence or absence of “x-prefetch-response: false”. The character string “x-prefetch-response: false” for use in discriminating the prefetch request message 602 is merely an example. Any character string may be used, as far as it is possible to discriminate the character string from other request messages.

In the case where the information storage unit 110 receives the prefetch request message 602 illustrated in FIG. 6B, as well as the case in which the information storage unit 110 receives an ordinary HTTP request transmitted from the client 131, the information storage unit 110 may cause the cache managing unit 112 to execute a retrieval process, or transmit an HTTP request to the Web server 140. However, the information storage unit 110 does not replicate an HTTP response to the prefetch request message 602. Accordingly, it is possible to prevent that the prefetch processing unit 120 repeats a process of generating another prefetch request message 602 from an HTTP response to the prefetch request message 602. This makes it possible to prevent a chain of prefetches, and to prevent prefetch more than necessary. This is advantageous in reducing the processing load of the Web content prefetch control device 100.

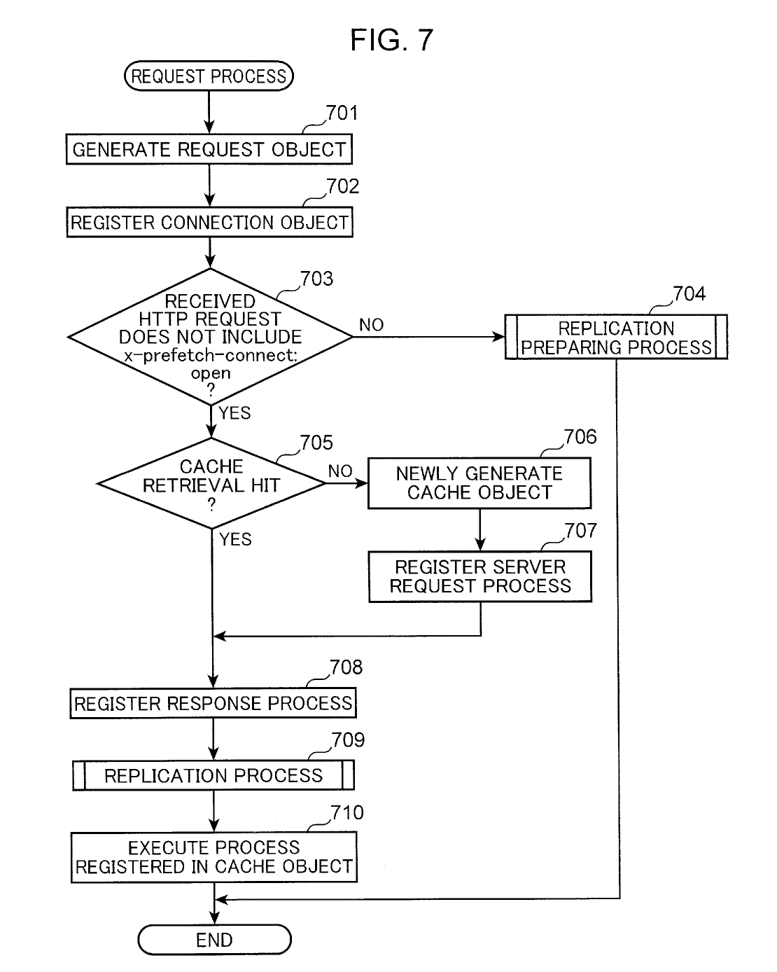

FIG. 7 is a flowchart illustrating an example of a request process to be executed by the cache managing unit 112.

In response to receiving an HTTP request via the client connecting unit 113, the cache managing unit 112 generates the request object illustrated in FIG. 3, and registers the contents of the HTTP request in each of the fields “HEADER” and “BODY” of the generated request object (in Step 701). Specifically, the cache managing unit 112 stores the header portion and the body portion constituting an HTTP request in the memory, registers the memory address for storing the header portion in the field “HEADER”, and registers the memory address for storing the body portion in the field “BODY”.

Subsequently, the cache managing unit 112 registers a connection object indicating communication connection when the client connecting unit 113 receives an HTTP request in the request object corresponding to the HTTP request (in Step 702). Referring to FIG. 4, assuming that the request object 405 is generated, the cache managing unit 112 registers the pointer of the connection object 407 in the field “CONNECTION OBJECT” of the request object 405.

Subsequently, the cache managing unit 112 determines whether the received HTTP request is the prefetch request message 601 (in Step 703). Specifically, the cache managing unit 112 reads the header portion stored in the memory address which is registered in the field “HEADER” of the request object corresponding to the received HTTP request, and determines whether the received HTTP request is the prefetch request message 601, based on a judgment as to whether “x-prefetch-connect: open” illustrated in FIG. 6A is described in the read header portion.

In the case where “x-prefetch-connect: open” is included in the header portion of the received HTTP request (NO in Step 703), the cache managing unit 112 determines that the received HTTP request is the prefetched request message 601, and requests the response replication unit 114 to execute a replication preparing process (in Step 704). Subsequently, when the replication preparing process is finished, the request process is finished. By performing the above operation, communication connection between the prefetch connecting unit 115 and the prefetch processing unit 120 is established.

On the other hand, in the case where “x-prefetch-connect: open” is not included in the header portion of the received HTTP request (YES in Step 703), the cache managing unit 112 determines that the received HTTP request is not the prefetched request message 601, and proceeds the process to Step 705.

Subsequently, the cache managing unit 112 retrieves a cache object stored in the cache area, with use of the request object generated in Step 701 (in Step 705).

In the case where the cachet object 401 corresponding to the request object is stored in the cache area (YES in Step 705), the cache managing unit 112 registers a response process in the cache object 401 (in Step 708). Specifically, as illustrated in FIG. 4, the cache managing unit 112 registers a response process in the procedure list 409 designated by the pointer registered in the field “MESSAGE PROCESS” as indicated by the reference sign 403 of the cache object 401 (in Step 708).

In the case where “x-prefetch-response: false” is included in the header portion of the received HTTP request, and the HTTP request is the prefetch request message 602 in Step 708, it is not necessary to transmit an HTTP response to the client 131 and to the prefetch processing unit 120. Accordingly, the cache managing unit 112 does not register a response process. In other words, in Step 708, the cache managing unit 112 registers a response process only in the case where the received HTTP request is an ordinary HTTP request.

On the other hand, in the case where a cache object corresponding to the request object is not stored in the cache area (NO in Step 705), the cache managing unit 112 newly generates a cache object 401 (in Step 706). Subsequently, the cache managing unit 112 registers a server request process in the procedure list 409 designated by a pointer registered in the field “MESSAGE PROCESS” as indicated by the reference sign 403 of the newly generated cache object 401 (in Step S707). Thereafter, if the request object is an ordinary HTTP request, the cache managing unit 112 registers a response process in the procedure list 409 (in Step 708).

Subsequently, the cache managing unit 112 requests the response replication unit 114 to execute a replication process, and waits for completion of the replication process (in Step 709).

Subsequently, the cache managing unit 112 executes the processes registered in the procedure list 409 designated by the pointers registered in the field “MESSAGE PROCESS” as indicated by the reference sign 403 in the order of registration, regarding the cache object 401 whose response process is registered in Step 708 (in Step 710). For instance, in the case where cache retrieval has failed in Step 705, the cache managing unit 112 executes a server request process and a response process in this order. In the case where cache retrieval was successful, the cache managing unit 112 executes only a response process.

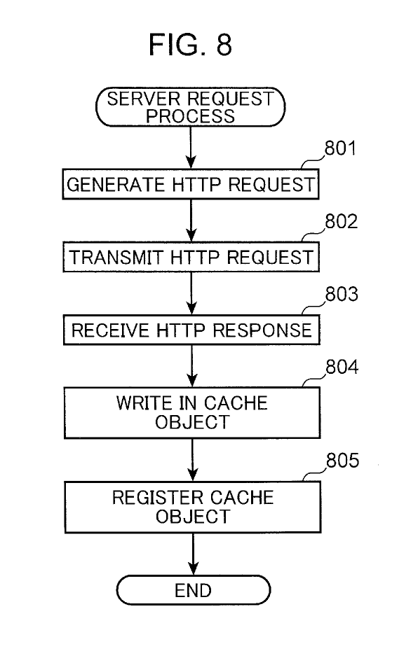

FIG. 8 is a flowchart illustrating an example of a server request process to be executed when the information storage unit 110 acquires Web content from the Web server 140.

The server request process is executed in the case where an HTTP response from the Web server 140 is not stored in the cache. Accordingly, when the server request process is executed, the HTTP response of the request object generated in Step 701 in FIG. 7 is not registered in the cache object 401. The server request process is a process to be executed in Step 710 in FIG. 7.

First of all, the server connecting unit 111 receives a request object from the cache managing unit 112, and generates an HTTP request for acquiring Web content from the Web server 140 (in Step 801).

Subsequently, the server connecting unit 111 transmits the generated HTTP request to the Web server 140, and waits for an HTTP response from the Web server 140 (in Step S802).

Subsequently, when the server connecting unit 111 receives an HTTP response from the Web server 140 (in Step 803), the cache managing unit 112 writes the contents of the HTTP response in the cache object 401 (in Step 804). In the example of FIG. 4, the cache managing unit 112 stores the HTTP response in the memory. Subsequently, the cache managing unit 112 registers the memory address for storing the header portion of the HTTP response in the field “RESPONSE HEADER” of the cache object 401, and registers the memory address for storing the body portion of the HTTP response in the field “RESPONSE BODY”, whereby the contents of the HTTP response are written in the cache object 401.

Subsequently, the cache managing unit 112 registers the cache object having the contents of the HTTP response written therein in the cache area (in Step 805), and the server request process is finished.

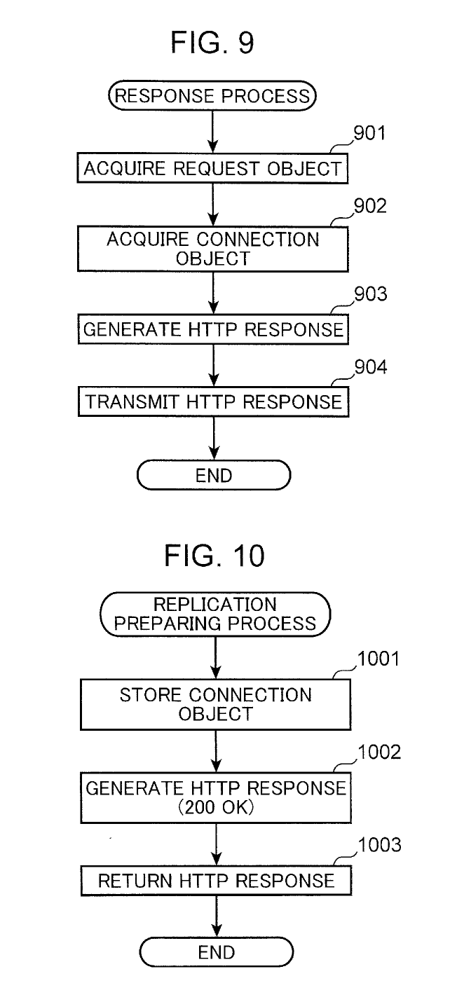

FIG. 9 is a flowchart illustrating an example of a response process to be executed by the information storage unit 110 with respect to the client 131. The response process is a process to be executed in Step 710 in FIG. 7.

The following steps are applied to each of the request objects included in the request object list 404 associated with the cache object 401.

The cache managing unit 112 acquires each of the request objects included in the request object list 404 (in Step 901), and acquires a connection object associated with each of the acquired request objects (in Step 902). In the example of FIG. 4, the request objects 405 and 406 are included in the request object list 404. Accordingly, the cache managing unit 112 acquires the connection object 407 associated with the request object 405, and the connection object 408 associated with the request object 406.

Subsequently, the cache managing unit 112 generates an HTTP response from the corresponding cache object (in Step 903). The generated HTTP response is transmitted to the client connecting unit 113 together with the acquired connection object via the response replication unit 114.

Subsequently, the client connecting unit 113 transmits the received HTTP response to the client 131 via the communication connection indicated by the received connection object (in Step 904). In the example of FIG. 4, an HTTP response including the contents registered in the field “RESPONSE HEADER” or “RESPONSE BODY” of the cache object 401 is generated, and the generated HTTP response is transmitted to the communication connection indicated by the connection object 407 and to the communication connection indicated by the connection object 408.

FIG. 10 is a flowchart illustrating an example of the replication preparing process in Step 704 in FIG. 7. The replication preparing process is executed, in the case where the prefetch request message 601 i.e. an HTTP request describing the character string “x-prefetch-connect: open” is received.

First of all, the response replication unit 114 stores, on the memory, a current connection object for use in executing the replication process to be described later (in Step 1001). The current connection object is a connection object indicating communication connection used when the prefetch processing unit 120 transmits the prefetch request message 601 to the client connecting unit 113.

Subsequently, the response replication unit 114 generates an HTTP response indicating that the receiving process of the prefetch request message 601 has been properly completed (in Step 1002), and transmits the HTTP response to the prefetch processing unit 120 via the prefetch connecting unit 115 (in Step 1003). By performing the above operation, communication connection between the prefetch connecting unit 115 and the prefetch processing unit 120 is established.

Regarding HTTP, communication connection is cut off in response to acquisition of an HTTP response to an HTTP request. Accordingly, when an HTTP response is transmitted to the prefetch processing unit 120 in Step 1003, communication connection between the prefetch processing unit 120 and the prefetch connecting unit 115 is cut off. If such an operation is performed, the response replication unit 114 is incapable of transmitting the HTTP response to the prefetch processing unit 120 via the prefetch connecting unit 115 in the replication process to be described later. Further, in the replication process, there is proposed an idea of establishing communication connection between the prefetch connecting unit 115 and the prefetch processing unit 120 by transmitting the HTTP request from the prefetch connecting unit 115 to the prefetch processing unit 120. According to this configuration, however, the prefetch processing unit 120 functions as a server, and the prefetch connecting unit 115 functions as a client. This may complicate the design of the prefetch connecting unit 115. In view of the above, in the embodiment, in Step 1001, a connection object is stored in the memory to thereby prevent cutoff of communication connection between the prefetch connecting unit 115 and the prefetch processing unit 120 when the replication preparing process is finished.

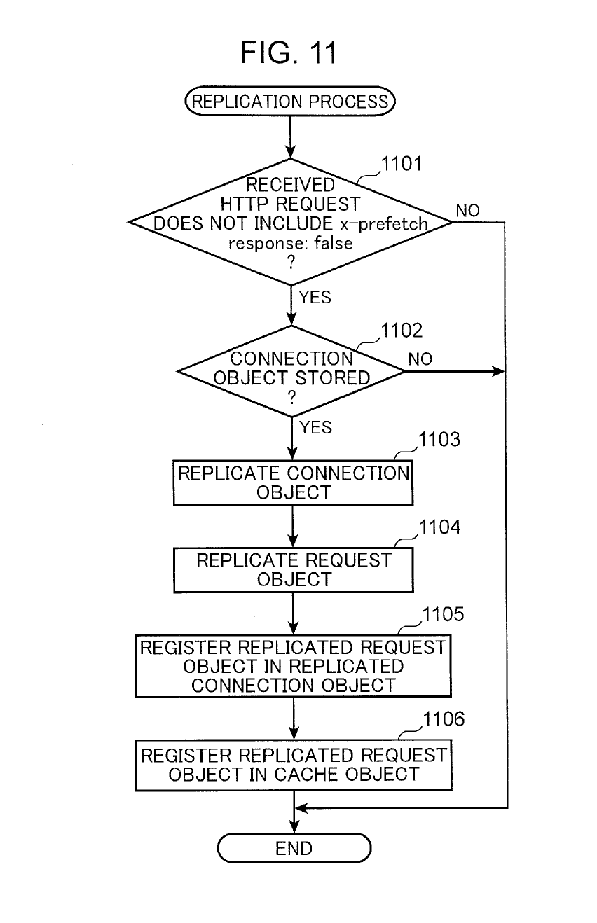

FIG. 11 is a flowchart illustrating an example of the replication process to be executed by the response replication unit 114 in Step 709 in FIG. 7.

First of all, the response replication unit 114 determines whether the received HTTP request is the prefetch request message 602 (in Step 1101). Specifically, the response replication unit 114 determines whether the received HTTP request is the prefetch request message 602 based on a judgment as to whether “x-prefetch-response: false” is included in the header portion of the received HTTP request.

In the case where “x-prefetch-response: false” is included in the header portion of the received HTTP request (NO in Step 1101), the response replication unit 114 determines that the received HTTP request is the prefetch request message 602, finishes the replication process, and the replication process is returned to Step 710 in FIG. 7.

In the above configuration, in Step 710, the process of caching a prefetch-related HTTP response in the cache area is executed. In the example of FIG. 4, assuming that the request object 405 is a request object of the prefetch request message 602, if an HTTP response corresponding to the request object 405 is stored in the cache area, a server request process and a response process are not registered into the cache object 401. As a result, in Step 710, a server request process and a response process are not executed. Accordingly, a prefetch-related HTTP response is not transmitted to the prefetch processing unit 120, and it is possible to prevent a chain of prefetches.

On the other hand, if an HTTP response corresponding to the request object 405 is not stored in the cache area, a server request process is registered in the cache object 401. Accordingly, the server request process illustrated in FIG. 8 is executed. Thus, a prefetch-related HTTP response is acquired from the Web server 140, and is stored in the cache area. However, since a response process is not registered, the response process is not executed. Accordingly, a prefetch-request-related HTTP response is not transmitted to the prefetch processing unit 120, and it is possible to prevent a chain of prefetches.

Referring back to Step 1101, in the case where “x-prefetch response: false” is not included in the header portion of the received HTTP request (YES in Step 1101), the response replication unit 114 determines that the received HTTP request is an ordinary HTTP request transmitted from the client 131, and determines whether there is a connection object of the prefetch processing unit 120 stored by the response replication unit 114 (in Step 1102). In this example, the connection object to be stored by the response replication unit 114 is the connection object stored in Step 1001 in FIG. 10, specifically, the connection object indicating communication connection established between the prefetch connecting unit 115 and the prefetch processing unit 120.

Even in the case where the communication connection between the prefetch connecting unit 115 and the prefetch processing unit 120 is not established, it is also possible to transmit the prefetch request message 602 including x-prefetch-response in the header portion from the prefetch processing unit 120 to the client connecting unit 113. In this case, the response replication unit 114 is not required to execute a replication process. In view of the above, the determination process of Step 1102 is provided in FIG. 11.

Subsequently, in the case where there is a connection object to be stored (YES in Step 1102), the response replication unit 114 proceeds the process to Step 1103.

On the other hand, in the case where there is no connection object to be stored (NO in Step S1102), the replication process is finished, and the process is proceeded to Step 710 in FIG. 7.

Subsequently, the response replication unit 114 replicates the connection object to be stored (in Step 1103). Subsequently, the response replication unit 114 replicates the request object (in Step 1104). The request object to be replicated is a request object of an ordinary HTTP request.

Subsequently, the response replication unit 114 registers the replicated connection object in the replicated request object (in Step 1105). Referring to FIG. 4, assuming that the request object 405 is a request object of an ordinary HTTP request, the response replication unit 114 replicates the request object, and registers the pointer of the connection object in the field “CONNECTION OBJECT” of the replicated request object to thereby register the replicated connection object in the replicated request object.

Subsequently, the response replication unit 114 registers the replicated request object in the cache object acquired from the cache managing unit 112 before the replication process is executed (in Step 1106), and finishes the replication process. In the example described referring to FIG. 4, the response replication unit 114 registers the replicated request object in the cache object 401 by including the replicated request object in the request object list 404.

When Step 1106 is finished, the process is proceeded to Step 710 in FIG. 7. In this case, a request object obtained by replicating a request object of an ordinary HTTP request is included in the request object list 404, in addition to the request object of the ordinary HTTP request. Therefore, if HTTP responses to these two request objects are not cached, an ordinary HTTP response is acquired from the Web server 140 by the server request process (see FIG. 8), and the acquired ordinary HTTP response is transmitted to the client 131 and to the prefetch processing unit 120 by the response process (see FIG. 9). In this case, the client connecting unit 113 transmits an ordinary HTTP response to the client 131, and the prefetch connecting unit 115 transmits an ordinary HTTP response. By performing the above operation, the ordinary HTTP response is transmitted to the client 131 and to the prefetch processing unit 120. Further, if HTTP responses of these two request objects are cached, only the response process (see FIG. 9) is executed, and an ordinary HTTP response is transmitted to the client 131 and to the prefetch processing unit 120 in the same manner as the case, in which HTTP responses of these two request objects are not cached.

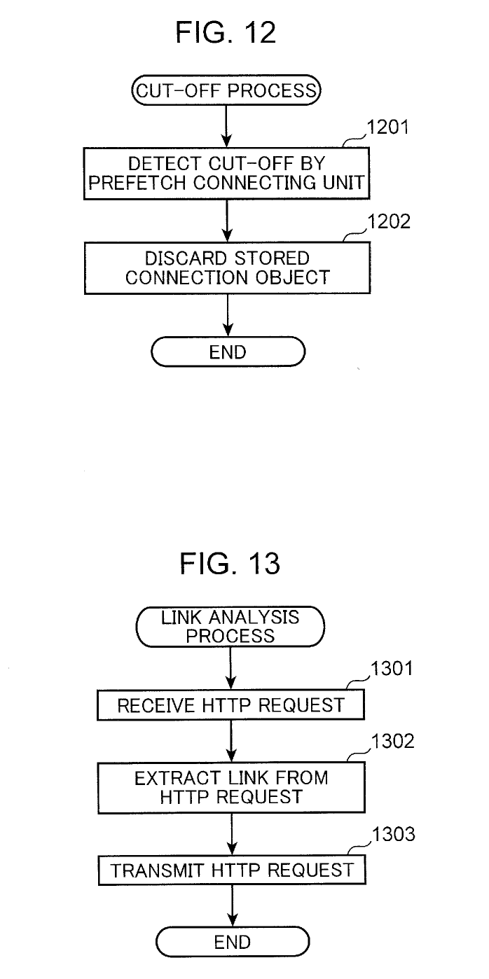

FIG. 12 is a flowchart illustrating an example of a cut-off process of communication connection between the prefetch connecting unit 115 and the prefetch processing unit 120.

The prefetch processing unit 120 may cut off the communication connection of its own in the case where the prefetch processing unit 120 detects the disorder of its own. For instance, in the case where the prefetch processing unit 120 is associated with an external process, and unrecoverable disorder occurs in the external process, the prefetch processing unit 120 determines that rebooting the prefetch processing unit 120 and the external process is the only way to recover. In such an occasion, the prefetch processing unit 120 cuts off the communication connection with the prefetch connecting unit 115. As an alternative, there is proposed an idea of providing a configuration, in which the prefetch processing unit 120 itself cuts off the communication connection with the prefetch connecting unit 115, in the case where temporary interruption of the prefetch process is required, in the aspect of processing load.

First of all, when the prefetch processing unit 120 cuts off communication connection with the prefetch connecting unit 115, the prefetch connecting unit 115 detects the cutoff (in Step 1201). For instance, in communication using a socket, there is provided a configuration, in which in response to closing the socket at one of the nodes, a communication error is notified to the other of the nodes. Therefore, in the case where the prefetch connecting unit 115 receives a communication error to be transmitted from the prefetch processing unit 120 in closing the socket, the prefetch connecting unit 115 may detect cutoff of the communication connection with the prefetch processing unit 120.

Subsequently, the prefetch connecting unit 115 instructs the response replication unit 114 to discard the stored connection object (in Step 1202).

Subsequently, after the response replication unit 114 discards the stored connection object, the prefetch connecting unit 115 finishes the cut-off process.

In executing the above process, the replicated request object and the replicated connection object are stored in the information storage unit 110 until a response process is executed. Accordingly, if the cache managing unit 112 is incapable of acquiring a connection object in Step 902 in the response process (see FIG. 9), the replicated request object and the replicated connection object may be discarded.

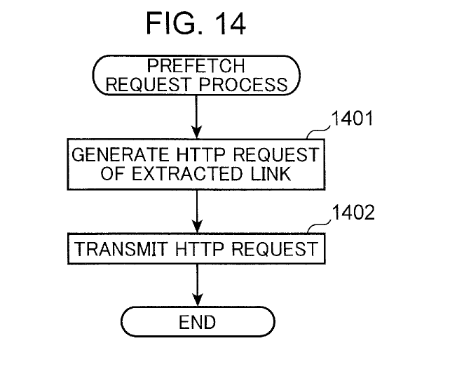

Subsequently, the process to be executed by the prefetch processing unit 120 is described referring to FIG. 13 and FIG. 14. FIG. 13 is a flowchart illustrating an example of a link analysis process.

First of all, in response to receiving an HTTP response from the prefetch connecting unit 115 (in Step 1301), the link processing unit 121 extracts a link included in the HTTP response (in Step 1302).

Subsequently, the link processing unit 121 transfers the link information indicating the extracted link to the request generating unit 122 (in Step 1303), and finishes the process. As a link extraction method, there is proposed a text process using a regular expression. For instance, the link processing unit 121 may detect a character string surrounded by the double quotation marks and started with a character string http by the text process, and may extract the detected character string as a link.

FIG. 14 is a flowchart illustrating an example of the prefetch request process. The request generating unit 122 receives the link information from the link processing unit 121, and generates an HTTP request corresponding to the link indicated by the received link information (in Step 1401). In the case where there are a plurality of received link information, the request generating unit 122 generates HTTP requests by the same number as the number of the received links.

Further, the request generating unit 122 generates an HTTP request so that the generated HTTP request is identifiable as the prefetch request message 602. For instance, as illustrated in FIG. 6B, the request generating unit 122 generates an HTTP request describing a predetermined character string (x-prefetch-response: false) in the header portion. In the case of the prefetch request message 601, as illustrated in FIG. 6A, the request generating unit 122 may describe a predetermined character string (x-prefetch-connect: open) in the header portion. The request generating unit 122 may periodically transmit the prefetch request message 601 for establishing communication connection with the prefetch connecting unit 115.

Subsequently, the request generating unit 122 transmits an HTTP request generated in Step 1401, specifically, the prefetch request message 602 to the client connecting unit 113 (Step 1402).

When the client connecting unit 113 receives the prefetch request message 602, the information storage unit 110 transfers the prefetch request message 601 to the Web server 140, acquires a prefetch-related HTTP response from the Web server 140, and caches the acquired prefetch-related HTTP response. Thereafter, in the case where the client 131 transmits an ordinary HTTP request to the information storage unit 110, and the information storage unit 110 caches an HTTP response to the ordinary HTTP request, which is received in response to a prefetch-related HTTP request, the information storage unit 110 transmits the HTTP response to the client 131. Thus, the client 131 can speedily acquire an HTTP response.

In this way, according to the embodiment, the response replication unit 114 is capable of replicating an ordinary HTTP response to an ordinary HTTP request from the client 131, and is capable of transmitting the replicated ordinary HTTP response to the prefetch processing unit 120 via the prefetch connecting unit 115. Further, the prefetch processing unit 120 is capable of receiving the replicated HTTP response, analyzing the contents of the received replicated HTTP response, and transmitting the prefetch request message 602 to the information storage unit 110 in the same format as the ordinary HTTP request. Further, in the case where the response replication unit 114 receives an HTTP response to the prefetch request message 602, the response replication unit 114 caches the HTTP response, without transmitting the HTTP response to the prefetch processing unit 120. Accordingly, it is possible to prevent a chain of prefetches.

In the foregoing, a Web content prefetch control device according to an aspect of the invention has been described based on an embodiment. The invention, however, is not limited to the embodiment. Various modifications applied to the embodiment or configurations obtained by combining constituent elements in embodiments different from each other created by a person skilled in the art are also included in the scope of the invention, as far as such modifications and configurations do not depart from the gist of the invention.

For instance, as far as the client 131, the information storage unit 110, and the prefetch processing 120 are each configured as an independent process to be executable, the client 131, the information storage unit 110, and the prefetch processing unit 120 may be provided in one computer, or may be provided in computers different from each other.

Further, in the embodiment, communication between the client connecting unit 113 and the client 131, communication between the client connecting unit 113 and the prefetch processing unit 120, and communication between the prefetch connecting unit 115 and the prefetch processing unit 120 are performed by using an HTTP. Alternatively, as far as the same means as used in communication between the client 131 and the client connecting unit 113 is used, communication between the client connecting unit 113 and the prefetch processing unit 120, and communication between the prefetch connecting unit 115 and the prefetch processing unit 120 may be performed by any means. An example of other communication means is FTP (File Transfer Protocol). Using the conventional communication means as communication means makes it possible to implement a configuration provided with a prefetch function, while minimizing the amount of change with respect to a configuration corresponding to a conventional proxy server (namely, the server connecting unit 111, the cache managing unit 112, and the client connecting unit 113 in the embodiment).

Further, in the embodiment, the information storage unit 110 is provided with the response replication unit 114 and the prefetch connecting unit 115, in addition to the server connecting unit 111, the cache managing unit 112, and the client connecting unit 113 corresponding to the functions provided in a conventional proxy server. Alternatively, the response replication unit 114 and the prefetch connecting unit 115 may be provided in the prefetch processing unit 120.

In the above modification, the response replication unit 114 may monitor an HTTP response to be transmitted from the cache managing unit 112, and may replicate the HTTP response by acquiring a prefetch-related HTTP response, out of the HTTP responses. According to this configuration, it is possible to further reduce the amount of change with respect to a conventional proxy server.

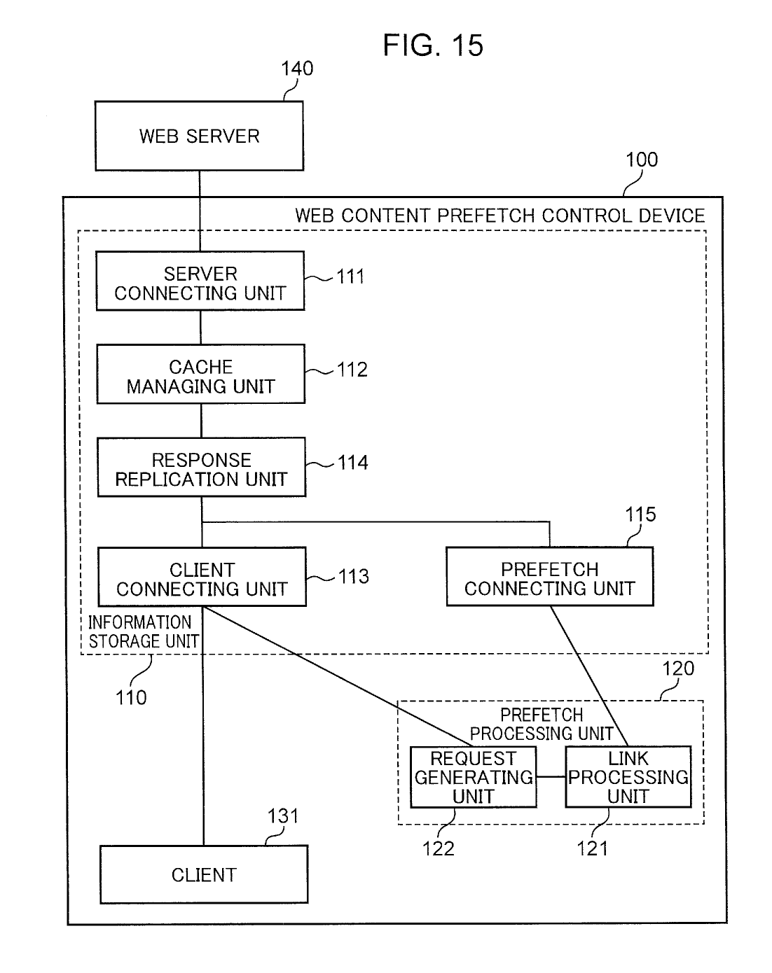

Further, in the example of FIG. 1, the client 131 is provided in a computer different from the Web content prefetch control device 100. Alternatively, as illustrated in FIG. 15, a client 131 may be included in a Web content prefetch control device 100. FIG. 15 is a diagram illustrating an example of a configuration of a system including the Web content prefetch control device 100, in the case where the client 131 is included in the Web content prefetch control device 100.

According to the configuration illustrated in FIG. 15, even when the Web content prefetch control device 100 and the client 131 are configured on one computer, it is possible to execute a process relating to prefetch by a process (a prefetch processing unit 120), which is independent from both of a browser (the client 131) and a proxy server (an information storage unit 110). Further, providing a prefetch interface (a prefetch connecting unit 115) using an existing interface (a communication protocol) makes it possible to minimize the amount of change with respect to a proxy server.

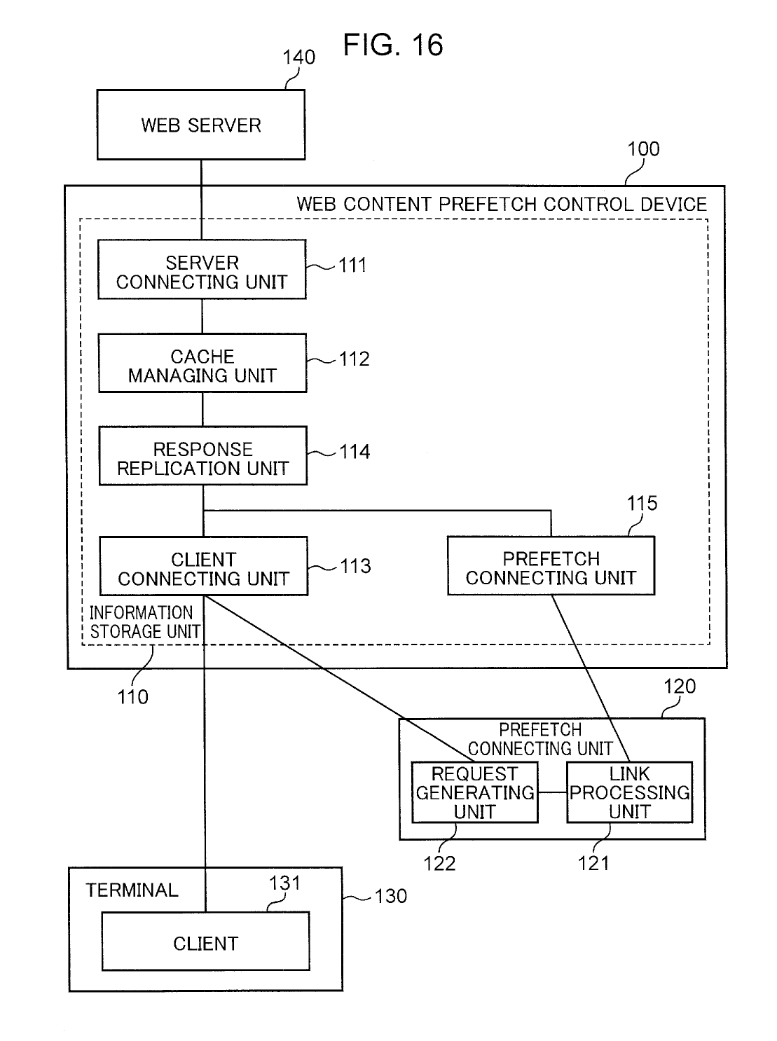

Further, as illustrated in FIG. 16, an information storage unit 110, a prefetch processing unit 120, and a client 131 may be configured of computers different from each other. FIG. 16 is a diagram illustrating an example of a configuration of a system including a Web content prefetch control device 100, when the information storage unit 110, the prefetch processing unit 120, and the client 131 are constituted of computers different from each other. In FIG. 16, the Web content prefetch control device 100 is constituted of the information storage unit 110, and a computer constituting the Web content prefetch control device 100, a computer constituting the prefetch processing unit 120, and a computer constituting the client 131 are connected to be communicable with each other via a network.

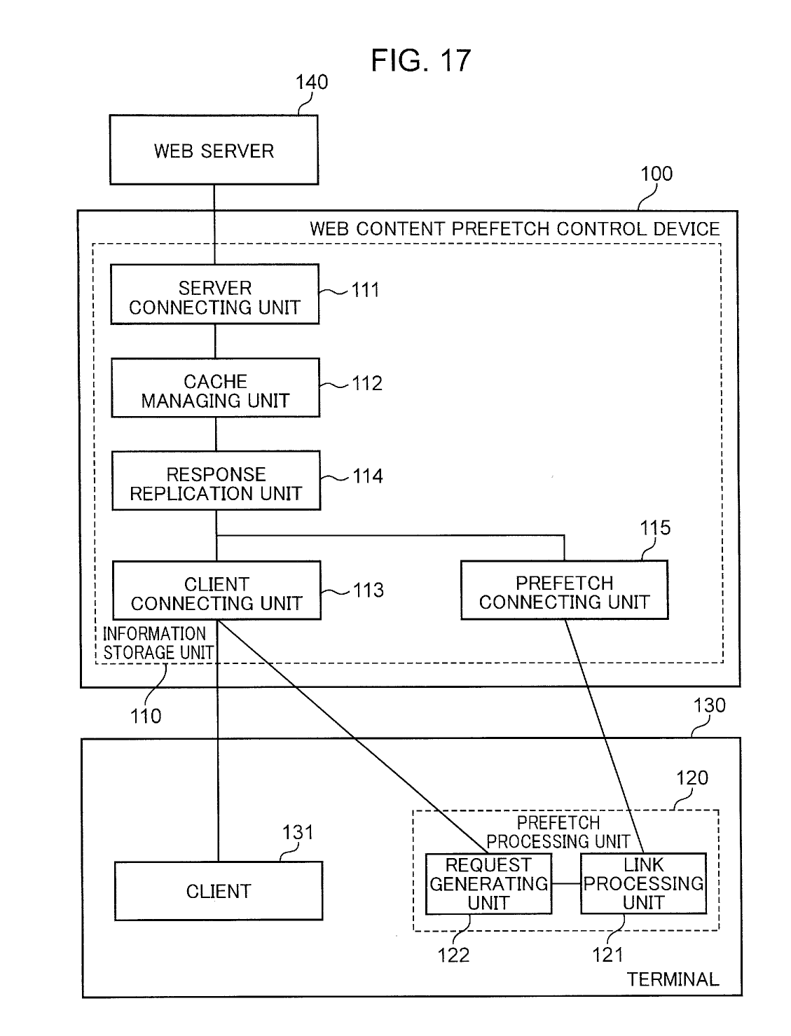

Further, as illustrated in FIG. 17, an information storage unit 110, a client 131, and a prefetch processing unit 120 may be configured of computers different from each other. FIG. 17 is a diagram illustrating an example of a configuration of a system including a Web content prefetch control device 100, when the information storage unit 110, the client 131, and the prefetch processing unit 120 are constituted of computers different from each other.

In FIG. 17, the Web content prefetch control device 100 is constituted of the information storage unit 110. A terminal 130 is provided with the prefetch processing unit 120 and the client 131. A computer constituting the Web content prefetch control device 100, and a computer constituting the terminal 130 are connected to be communicable with each other via a network.

Further, in the embodiment, the predetermined character strings illustrated in FIG. 6A and FIG. 6B are described in a header portion in order to identify a prefetch request message. A method for identifying a prefetch request message is not limited to the above example. For instance, it is possible to set in advance one or more TCP port numbers to be used in transmitting prefetch request messages 601 and 602, and to identify the prefetch request messages 601 and 602 from each other, with use of the port numbers. In the modification, it is not necessary to describe predetermined character strings indicating the prefetch request messages 601 and 602 in an HTTP request.

Further, the Web content prefetch control device 100 according to the embodiment is applicable to any computer, electronic device, information device, AV device, communication device, and household electrical appliance. For instance, it is possible to apply the WEB content prefetch control device 100 to PCs (Personal Computers), mobile information terminals (such as mobile phones, smartphones, and PDAs), TV receivers, hard disk recorders, various disc recorders using DVDs and Blu-ray Discs, various disc players using DVDs and Blu-ray Discs, and car navigation systems.

Further, the embodiment is not only directed to the Web content prefetch control device 100 provided with the aforementioned processing units, but also directed to a Web content prefetch control method including the processing units provided in the WEB content prefetch control device 100 as steps. Further, the embodiment is also directed to a computer program which causes a computer to execute the steps included in the method. Further, the embodiment is also directed to a configuration, in which the computer program is distributed via a non-temporary computer-readable recording medium such as a CD-ROM, or via a communication network such as the Internet.

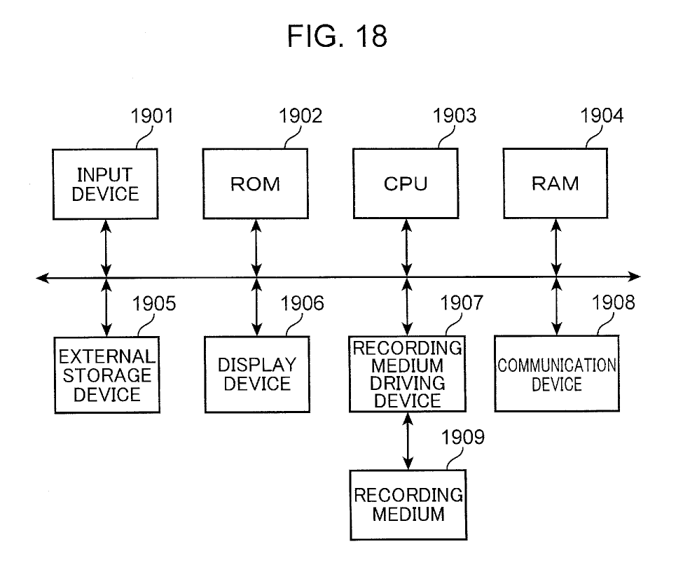

FIG. 18 is a diagram illustrating an example of a hardware configuration of a computer, when the Web content prefetch control device 100 is implemented by the computer.

The computer is provided with an input device 1901, an ROM (Read Only Memory) 1902, a CPU (Central Processing Unit) 1905, an RAM (Random Access Memory) 1904, an external storage device 1905, a display device 1906, a recording medium driving device 1907, and a communication device 1908. Each of the blocks is connected to an internal bus. Various data is input to and output from the blocks via the bus. Various processes are executed under the control of the CPU 1903.

The input device 1901 is constituted of a keyboard and a mouse, and is used for inputting various data by the user. A system program such as BIOS (Basic Input/Output System) is stored in the ROM 1902. The external storage device 1905 is constituted of a hard disk drive. A predetermined OS (Operating System), and a Web content prefetch control program which causes the computer to function as the Web content prefetch control device 100 are stored in the external storage device 1905. The CPU 1903 reads the OS from the external storage device 1905, and controls the operation of each of the blocks. The RAM 1904 is used as a working area of the CPU 1903.

The display device 1906 is constituted of e.g. a liquid crystal display or an organic EL display, and is configured to display various images under the control of the CPU 1903. The recording medium driving device 1907 is constituted of a DVD-ROM drive or a flexible disk drive.

The Web content prefetch control program is stored in the computer-readable recording medium 1909 such as a DVD-ROM, and is provided to the user. The user is allowed to install the Web content prefetch control program in the computer by causing the recording medium driving device 1907 to read the recording medium 1909. Further, the Web content prefetch control program may be stored in a server on the Internet, and the Web content prefetch control program may be installed in the computer by downloading the Web content prefetch control program from the server.

The communication device 1908 is constituted of a communication device for use in connecting a computer to an LAN or the Internet. The communication device 1908 is configured to transmit and receive data to and from other device via the Internet under the control of the CPU 1903.

The server connecting unit 111 and the client connecting unit 113 illustrated in FIG. 1 are implemented by causing the CPU 1903 to execute a program module of the Web content prefetch control program which functions the communication device 1908 as the server connecting unit 111 and the client connecting unit 113. In the configurations illustrated in FIG. 16 and FIG. 17, the prefetch connecting unit 115 is implemented by causing the CPU 1903 to execute a program module of the Web content prefetch control program which functions the communication device 1908 as the prefetch connecting unit 115.

Further, the cache managing unit 112, the response replication unit 114, and the prefetch connecting unit 115 illustrated in FIG. 1 are implemented by causing the CPU 1903 to execute the Web content prefetch control program.

Further, the cache managing unit 112 illustrated in FIG. 1 is implemented by causing the CPU 1903 to execute a program module of the Web content prefetch control program which functions a part of the RAM 1904 or a part of the external storage device 1905 as a cache area.

Further, the prefetch processing unit 120 illustrated in FIG. 15 is implemented by causing the CPU 1903 to execute a program module of the Web content prefetch control program. Further, the client 131 illustrated in FIG. 15 is implemented by causing the CPU 1903 to execute a browser program.

Further, each of the functional blocks of the Web content prefetch control device according to the embodiment as illustrated in FIG. 1 is typically implemented as a program to be processed by cooperation of a processor and an external memory. Alternatively, each of the functional blocks may be implemented by an LSI as an integrated circuit. Each of the functional blocks may be individually configured into a one-chip device, or a part or all of the functional blocks may be configured into a one-chip device. In this example, the integrated circuit is an LSI. The integrated circuit may also be called as an IC (Integrated Circuit), a system LSI, a super LSI, or an ultra LSI, depending on the degree of integration of the circuit.

Further, the circuit integration method is not limited to an LSI method. The integrated circuit may be implemented by a dedicated circuit or a general-purpose processor. Further, an FPGA (Field Programmable Gate Array) capable of programming after fabricating an LSI, or a reconfigurable processor capable of reconfiguring connection or setting of circuit cells within the LSI may also be used.

Further, if an integration circuit technology substantially equivalent to the LSI technology is developed in the future by the progress of semiconductor technology or by another technology derived from the semiconductor technology, it is needless to say that the functional blocks are integrated by using such a technology.

Further, a part or all of the constituent elements provided in the Web content prefetch control device according to the embodiment may be constituted of one system LSI (Large Scale Integration).

The system LSI is an ultra multi-functional LSI manufactured by integrating a plurality of components on one chip. Specifically, the system LSI is a computer system constituted of a microprocessor, an ROM (Read Only Memory), and an RAM (Random Access Memory). A computer program is stored in the ROM. The system LSI accomplishes the functions thereof by causing the microprocessor to operate in accordance with the computer program.

In this example, the integrated circuit is a system LSI. The integrated circuit may also be called as an IC, an LSI, a super LSI, or an ultra LSI, depending on the degree of integration of the circuit. Further, the circuit integration method is not limited to an LSI method. The integrated circuit may be implemented by a dedicated circuit or a general-purpose processor. Further, an FPGA (Field Programmable Gate Array) capable of programming after fabricating an LSI, or a reconfigurable processor capable of reconfiguring connection or setting of circuit cells within the LSI may also be used.

Further, if an integration circuit technology substantially equivalent to the LSI technology is developed in the future by the progress of semiconductor technology or by another technology derived from the semiconductor technology, it is needless to say that the functional blocks may be integrated by using such a technology, or such a technology may be applied to a bio-technology.

### SUMMARY OF EMBODIMENT

The following is a summary of the technical features of the embodiment.

(1) A Web content prefetch control device according to an aspect of the invention is a Web content prefetch control device connected to a Web server for storing Web content via a network, and configured to control prefetch of Web content linked to Web content in the Web server requested by a client. The Web content prefetch control device is provided with a client connecting unit which receives a Web content acquisition request from the client, and a prefetch request transmitted from a prefetch processing unit which performs the prefetch of Web content; a cache managing unit which stores Web content acquired from the Web server as responses to the Web content acquisition request and to the prefetch request, and transmits the responses; a response replication unit which receives the responses transmitted from the cache managing unit, and replicates the response to the Web content acquisition request, out of the responses; and a prefetch connecting unit which transmits, to the prefetch processing unit, the replicated response to the Web content acquisition request. Communication between the client connecting unit and the client, communication between the client connecting unit and the prefetch processing unit, and communication between the prefetch connecting unit and the prefetch processing unit are each performed with a same communication protocol.

According to the above configuration, the prefetch connecting unit transmits the replicated Web content to the prefetch processing unit, with use of the same communication protocol as the communication protocol to be used in communication between the client connecting unit and the client. Accordingly, a proxy server constituted of the cache managing unit, the response replication unit, the client connecting unit, and the prefetch connecting unit is capable of handling both of the client and the prefetch processing unit as a client. Thus, it is possible to implement a prefetch connecting unit by using the client connecting unit as an existing communication interface. As a result, providing a response replication unit and a prefetch connecting unit using an existing communication interface in a proxy server makes it possible to configure the Web content prefetch control device. Thus, it is possible to configure the Web content prefetch control device, while minimizing the amount of change with respect to a proxy server.

(2) The prefetch request may include type information indicating the prefetch request, and when the response replication unit receives a response to the prefetch request, the response replication unit may determine whether the received response is a response to the prefetch request based on the type information, and when the response replication unit determines that the received response is a response to the prefetch request, the response replication unit may be inoperative to replicate the received response.

According to the above configuration, the prefetch request includes type information indicating the prefetch request. Accordingly, the response replication unit is capable of easily determining whether the received response is the prefetch request. Further, the response to the prefetch request is not replicated, and a replicated response is not transmitted to the prefetch processing unit. Accordingly, it is possible to prevent prefetch of a response to the prefetch request, and it is possible to prevent a chain of prefetches. Thus, it is possible to prefetch only the Web content having a high possibility of browsing by the client. Further, Web content having a low possibility of browsing by the client is not prefetched and cached. Accordingly, it is possible to suppress consumption of memory resources.

(3) When the response replication unit determines that the received response is not a response to the prefetch request based on the type information, the response replication unit may replicate the received response.

According to the above configuration, when it is determined that the received response is not a response to the prefetch request, in other words, the received response is a response to the Web content acquisition request, the received response is replicated, and the replicated response is transmitted to the prefetch processing unit. Therefore, it is possible to prefetch and cache only a response having a high possibility of browsing by the client.

(4) The prefetch request may be an HTTP message, the type information may be a predetermined character string described in an HTTP header of the HTTP message, and when the character string is included in the HTTP header, the response replication unit may determine that the HTTP message is the prefetch request.

According to the above configuration, it is possible to determine whether the HTTP message is a prefetch request by the presence or absence of a predetermined character string described in the HTTP header of the HTTP message.

(5) The prefetch request may include a first prefetch request for establishing communication connection between the prefetch processing unit and the prefetch connecting unit, and when the client connecting unit receives the first prefetch request, the response replication unit may establish the communication connection between the prefetch connecting unit and the prefetch processing unit.

According to the above configuration, communication connection between the prefetch connecting unit and the prefetch processing unit is established by receiving the first prefetch request transmitted from the prefetch processing unit by the client connecting unit. Accordingly, the prefetch connecting unit itself is not required to transmit a connection request to the prefetch processing unit and to establish communication with the prefetch processing unit. Thus, it is possible to handle the prefetch processing unit as a client, and it is possible to implement a prefetch connecting unit by using an existing communication interface, as well as the client connecting unit, without using a dedicated communication interface.

(6) The prefetch request may include a second prefetch request for prefetching the Web content, and when the response received from the cache managing unit is a response to the second prefetch request, the response replication unit may be inoperative to replicate the received response.

According to the above configuration, it is possible to prevent replication of a response to the second prefetch request, and to transmit the replicated response to the prefetch processing unit. Further, it is possible to prevent generation of a second prefetch request with respect to the response to the second prefetch request.

(7) When the cache managing unit stores the response to the second prefetch request, the cache managing unit may transmit the stored response to the response replication unit.

According to the above configuration, as far as a response to the second prefetch request is cached, the response is transmitted to the response replication unit, without the need of accessing the Web server. Accordingly, the response replication unit is capable of promptly receiving the response. Since the response is a response to the second prefetch request, the response is not replicated by the response replication unit. Therefore, it is possible to implement the cache managing unit by a cache managing unit provided in an existing proxy server.

(8) The Web content prefetch control device may be further provided with the client, wherein the client connecting unit receives the Web content acquisition request from a client provided in the Web content prefetch control device.

According to the above configuration, it is possible to obtain substantially the same advantageous effects as in (1) by a configuration, in which the Web content prefetch control device and the client are implemented on one computer.

(9) The client may be provided with a computer connected to the Web content prefetch control device via the network, and the client connecting unit may receive the Web content acquisition request from the client.

According to the above configuration, it is possible to obtain substantially the same advantageous effects as in (1) by a configuration, in which the Web content prefetch control device and the client are implemented on computers different from each other.

(10) The Web content prefetch control device may be further provided with the prefetch processing unit, wherein the prefetch connecting unit transmits, to the prefetch processing unit provided in the Web content prefetch control device, the replicated response to the Web content acquisition request.

According to the above configuration, it is possible to obtain substantially the same advantageous effects as in (1) by a configuration, in which the Web content prefetch control device and the prefetch processing unit are implemented on one computer.

(11) The prefetch processing unit may be provided with a computer connected to the Web content prefetch control device via the network, and the prefetch connecting unit may transmit, to the prefetch processing unit, the replicated response to the Web content acquisition request.

According to the above configuration, it is possible to obtain substantially the same advantageous effects as in (1) by a configuration, in which the Web content prefetch control device and the prefetch processing unit are implemented on computers different from each other.

(12) The Web content prefetch control device may be further provided with a server connecting unit which acquires a response from the Web server by transmitting the Web content acquisition request and the prefetch request to the Web server, and transmits the acquired responses to the cache managing unit.

According to the above configuration, Web content is acquired via the server connecting unit.

### INDUSTRIAL APPLICABILITY

The Web content prefetch control device according to the invention is useful as a device for apparently speeding up access to Web content in a terminal such as a mobile terminal which belongs to a network of a large delay in time.

1. A Web content prefetch control device connected to a Web server for storing Web content via a network, and configured to control prefetch of Web content linked to Web content in the Web server requested by a client, comprising:
a client connecting unit which receives a Web content acquisition request from the client, and a prefetch request transmitted from a prefetch processing unit which performs the prefetch of Web content;
a cache managing unit which stores Web content acquired from the Web server as responses to the Web content acquisition request and to the prefetch request, and transmits the responses;
a response replication unit which receives the responses transmitted from the cache managing unit, and replicates the response to the Web content acquisition request, out of the responses; and
a prefetch connecting unit which transmits, to the prefetch processing unit, the replicated response to the Web content acquisition request, wherein
communication between the client connecting unit and the client, communication between the client connecting unit and the prefetch processing unit, and communication between the prefetch connecting unit and the prefetch processing unit are each performed with a same communication protocol.

2. The Web content prefetch control device according to claim 1, wherein
the prefetch request includes type information indicating the prefetch request, and
when the response replication unit receives a response to the prefetch request, the response replication unit determines whether the received response is a response to the prefetch request based on the type information, and when the response replication unit determines that the received response is a response to the prefetch request, the response replication unit is inoperative to replicate the received response.

3. The Web content prefetch control device according to claim 2, wherein
when the response replication unit determines that the received response is not a response to the prefetch request based on the type information, the response replication unit replicates the received response.

4. The Web content prefetch control device according to claim 2, wherein
the prefetch request is an HTTP message,
the type information is a predetermined character string described in an HTTP header of the HTTP message, and
when the character string is included in the HTTP header, the response replication unit determines that the HTTP message is the prefetch request.

5. The Web content prefetch control device according to claim 1, wherein
the prefetch request includes a first prefetch request for establishing communication connection between the prefetch processing unit and the prefetch connecting unit, and
when the client connecting unit receives the first prefetch request, the response replication unit establishes the communication connection between the prefetch connecting unit and the prefetch processing unit.

6. The Web content prefetch control device according to claim 5, wherein
the prefetch request includes a second prefetch request for prefetching the Web content, and
when the response received from the cache managing unit is a response to the second prefetch request, the response replication unit is inoperative to replicate the received response.

7. The Web content prefetch control device according to claim 6, wherein
when the cache managing unit stores the response to the second prefetch request, the cache managing unit transmits the stored response to the response replication unit.

8. The Web content prefetch control device according to claim 1, further comprising the client, wherein
the client connecting unit receives the Web content acquisition request from a client provided in the Web content prefetch control device.

9. The Web content prefetch control device according to claim 1, wherein
the client is provided with a computer connected to the Web content prefetch control device via the network, and
the client connecting unit receives the Web content acquisition request from the client.

10. The Web content prefetch control device according to claim 1, further comprising the prefetch processing unit, wherein
the prefetch connecting unit transmits, to the prefetch processing unit provided in the Web content prefetch control device, the replicated response to the Web content acquisition request.

11. The Web content prefetch control device according to claim 1, wherein
the prefetch processing unit is provided with a computer connected to the Web content prefetch control device via the network, and
the prefetch connecting unit transmits, to the prefetch processing unit, the replicated response to the Web content acquisition request.

12. The Web content prefetch control device according to claim 1, further comprising:
a server connecting unit which acquires a response from the Web server by transmitting the Web content acquisition request and the prefetch request to the Web server, and transmits the acquired responses to the cache managing unit.

13. A non-transitory computer-readable recording medium which stores a web content prefetch control program which causes a computer to function as a Web content prefetch control device connected to a Web server for storing Web content via a network, and configured to control prefetch of Web content linked to Web content in the Web server requested by a client, the program causing the computer to function as:
a client connecting unit which receives a Web content acquisition request from the client, and a prefetch request transmitted from a prefetch processing unit which performs the prefetch of Web content;
a cache managing unit which stores Web content acquired from the Web server as responses to the Web content acquisition request and to the prefetch request, and transmits the responses; and
a response replication unit which receives the responses transmitted from the cache managing unit, and replicates the response to the Web content acquisition request, out of the responses; and
a prefetch connecting unit which transmits, to the prefetch processing unit, the replicated response to the Web content acquisition request, wherein
communication between the client connecting unit and the client, communication between the client connecting unit and the prefetch processing unit, and communication between the prefetch connecting unit and the prefetch processing unit are each performed with a same communication protocol.

14. A Web content prefetch control method for a Web content prefetch control device connected to a Web server for storing Web content via a network, and configured to control prefetch of Web content linked to Web content in the Web server requested by a client, the method comprising:
a client connecting step of receiving a Web content acquisition request from the client, and a prefetch request transmitted from a prefetch processing unit which performs the prefetch of Web content;
a cache managing step of storing Web content acquired from the Web server as responses to the Web content acquisition request and to the prefetch request, and of transmitting the responses; and
a response replication step of receiving the responses transmitted in the cache managing step, and of replicating the response to the Web content acquisition request, out of the responses; and
a prefetch connecting step of transmitting, to the prefetch processing unit, the replicated response to the Web content acquisition request, wherein
communication between the client connecting unit which performs the client connecting step and the client, communication between the client connecting unit and the prefetch processing unit, and communication between the prefetch connecting unit which performs the prefetch connecting step and the prefetch processing unit are each performed with a same communication protocol.
